(19) United States
(12) Patent Application Publication
(10) Pub. No.: US 2009/0315898 A1
(43) Pub. Date: Dec. 24, 2009

(54) PARAMETER CODING PROCESS FOR AVATAR ANIMATION, AND THE DECODING PROCESS, SIGNAL, AND DEVICES THEREOF

(75) Inventors: David Cailliere, Paris (FR); Gildas Belay, Trelevern (FR); Gaspard Breton, Cesson-Sevigne (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/305,718

(22) PCT Filed: Jun. 26, 2007
(86) PCT No.: PCT/FR2007/051532

§ 371 Date: Feb. 24, 2009

(30) Foreign Application Priority Data
Jun. 27, 2006 (FR) 0652668

(51) Int. Cl. G06T 13/00

(52) U.S. Cl. 345/473

(57) ABSTRACT

The invention relates to a method for coding animation parameters for a character (A) with which are associated morphological values, said animation parameters comprising a translation parameter associated with at least one part of said character (A), characterized in that to code an intrinsic translation of said part of said character (A) by a translation vector, said translation parameter contains a value which is dependent on said vector and on one of said morphological values.

The present invention relates generally to the field of virtual reality, and more precisely to the coding of animation parameters for avatars.

Currently two major standards offer a structure making it possible to animate a three-dimensional character, or avatar.

The first is the HAnim or Humanoid Animation standard, itself arising from the VRML or “Virtual Reality Modelling Language” standard. This standard defines for avatars a hierarchical articular structure called a skeleton, composed of segments. With each segment of the skeleton of an avatar is associated a part of the geometric envelope of the avatar. This association in fact corresponds to a segmentation of the avatar into removable elements, thereby making it possible to animate the avatar by applying transformations of the translation, rotation or scaling type to these various elements of one and the same skeleton, or articulated chain. The part of the geometric envelope of the avatar attached to a segment then follows the movement of this segment, either in a rigid manner or an elastic manner by virtue of a technique called “skinning”. Today most infography tools making it possible to create avatars implement the typical skeleton defined by the HAnim standard.

The second standard is the MPEG4 BBA or “Motion Picture Expert Group 4 Bone Based Animation” standard, which takes up the foundations of the HAnim standard, in particular the segmenting of avatars into removable elements. But the MPEG4 BBA standard does not define any typical skeleton, it offers more flexibility since it makes it possible to construct, while complying with the principle of the HAnim standard, any skeleton, for example an animal skeleton.

The MPEG4 BBA standard itself comprises a derived standard, the MPEG4 BAP or “Motion Picture Expert Group 4 Body Animation Parameter” standard which defines fixed animation parameters associated with the typical skeleton of the HAnim standard. This derived standard is therefore once again less flexible than the MPEG4 BBA standard, which is not limited to a single skeleton and makes it possible to define various animation parameters for a given skeleton.

To ensure the compatibility of an animation between different avatars, the HAnim standard has put in place constraints on the topology of the typical skeleton, and has defined a rest pose for avatars before animation. This principle is also borrowed by the MPEG4 BBA standard.

Thus, in order for the exchanging of animation data between several typical skeletons defined by the HAnim standard to be possible, articulation levels are defined between the segments of the typical skeletons. These articulation levels have a very precise spatial dimensioning and positioning, which makes it possible to define a rest position for each skeleton. In this rest position, all the animation parameters such as defined in the HAnim, MPEG4 BAP or MPEG4 BBA standards, have a reference value. Thus for example the translation value for a segment of the typical skeleton in its rest position is initialized to the zero vector.

The animation of an avatar is then manifested as a succession of transformations performed from this rest position of the typical skeleton of the avatar. The animation parameters of the various segments of the typical skeleton are expressed in reference frames local to these segments. Thus the skeleton scaling parameters, as well as the skeleton-related rotation parameters, are expressed independently of the three-dimensional global Cartesian reference frame in which the geometry of the avatar is defined.

However, the skeleton translation parameters, even expressed in the reference frames local to the segments of the skeleton, are not totally independent of the scene in which the avatar is moving. In actual fact the lengths of the translation vectors are not expressed relative to the skeleton, but in a system of absolute measurement units. They are in fact expressed in meters in the HAnim standard, in millimeters in the MPEG4 BAP standard, and no measurement unit is advocated for the translation parameters in the MPEG4 BBA standard. This disparity in the definitions of the units of the translation vectors in the various standards is not practical for the designer of three-dimensional character animations.

Furthermore, the use of the articulation levels of the HAnim standard makes it possible, for all avatars constructed in compliance with the rules of these levels, to be animated with the same animation stream compatible with this standard. However, the animation streams containing the animation parameters are often coded separately from the morphological data of the characters. Thus in the MPEG4 standard the morphological data of the avatars and the animation parameters are dissociated, so as to be able to be coded and streamed separately, thereby alleviating numerous difficulties in terms of implementation. Specifically, the animation parameters are not totally independent of the morphology of the character to be animated. In particular the translation movements are in general smaller when they are performed by a small-size character than when they are performed by a character of larger size.

The aim of the present invention is to solve the drawbacks of the prior art by providing coding and decoding methods and devices making it possible to express the animation data for an avatar independently of the dimensions of the scene in which it is situated.

To this end, the invention proposes a method for coding animation parameters for a character with which are associated morphological values, said animation parameters comprising a translation parameter associated with at least one part of said character, characterized in that to code an intrinsic translation of said part of said character by a translation vector, said translation parameter contains a value which is dependent on said vector and on one of said morphological values.

In the coding method according to the invention, the translations intrinsic to the character to be animated, such as for example a translation of the pelvis of the character when it walks, are differentiated from those which are extrinsic to it, such as for example a translation when traveling in a lift. The translation parameters coding intrinsic translations are expressed, by this method, in relation to the skeleton of the character on the basis of anthropomorphic measurements calculated on the skeleton. This makes it possible to code animation streams separately from the morphology data of the avatars while complying, in the implementation of the animation, with the morphology of the character to be animated. Specifically, the coding according to the invention makes it possible to retain, for one and the same animation stream, when the character to be animated is changed, translations that are realistic with respect to the dimensions of the new character, since the intrinsic nature of the translations which relate to this new character is taken into account.

It should be noted, moreover, that the method according to the invention is not limited to the coding of human characters, but is usable on any type of animated object for which translation parameters are associated with parts of this object. The word “character” is in fact used in this patent application in the sense of any articulated object subjected to animation.

According to a preferred characteristic of the coding method according to the invention, one parameter from among said animation parameters makes it possible to determine whether said translation parameter codes a translation intrinsic to said character or a translation extrinsic to said character.

This makes it possible to code in the same animation stream, the movements relating to the three-dimensional scene in which the character is moving, or extrinsic movements, and the movements relating to the character, or intrinsic movements.

According to a preferred characteristic of the coding method according to the invention, said morphological values are lengths of segments of the skeleton of said character, said translation parameter is associated with a segment of the skeleton of said character, and to code an intrinsic translation of said segment by a translation vector, said translation parameter contains a value which is proportional to said vector and inversely proportional to the length of said segment.

In this characteristic of the coding method, the translation vector associated with a segment of the character is normalized by the length of this segment. This makes it possible to finely code the translations intrinsic to the character to be animated, by using a plurality of its morphological parameters.

The invention also relates to a method for decoding animation parameters for a character with which are associated morphological values, said animation parameters comprising a translation parameter associated with at least one part of said character, characterized in that to decode an intrinsic translation of said part of said character, the value of said translation parameter is multiplied by a factor of one of said morphological values.

According to a preferred characteristic of the decoding method according to the invention, said morphological values are lengths of segments of the skeleton of said character, said translation parameter being associated with a segment of the skeleton of said character, and in order to decode an intrinsic translation of a segment of the skeleton of said character, said method comprises the steps of:
Calculating the length of said segment,
Obtaining an estimation of the value of said translation in a system of absolute measurement units, by multiplying the value of said translation parameter by a factor proportional to the previously calculated length of said segment.

The invention further relates to a signal conveying animation parameters for a character with which are associated morphological values, said animation parameters comprising a translation parameter containing translation information for said part of said character in the form of a value included in said translation parameter, characterized in that said value has been evaluated as a function of one of said morphological values when said translation is intrinsic to the character.

According to a preferred characteristic of the signal according to the invention, said signal conveys a parameter making it possible to determine whether said translation is a translation intrinsic to the character or a translation extrinsic to the character.

The invention also relates to a device for coding animation parameters for a character with which are associated morphological values, characterized in that it comprises means suitable for implementing the coding method according to the invention.

The invention relates, moreover, to a device for decoding animation parameters for a character with which are associated morphological values, characterized in that it comprises means suitable for implementing the decoding method according to the invention.

The decoding method, as well as the signal and the devices, exhibit advantages analogous to those of the coding method according to the invention.

The invention further relates to a computer program comprising instructions for implementing the methods previously presented, when the latter are executed on a computer.

Other characteristics and advantages will become apparent on reading a preferred embodiment described with reference to the figures in which:

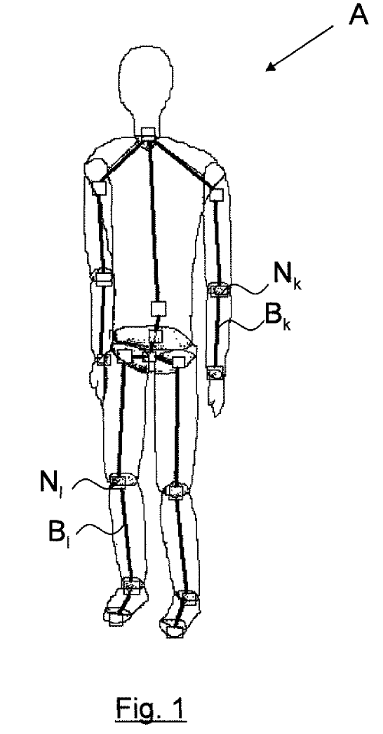

FIG. 1 represents an avatar to which is applied a typical skeleton of the HAnim standard,

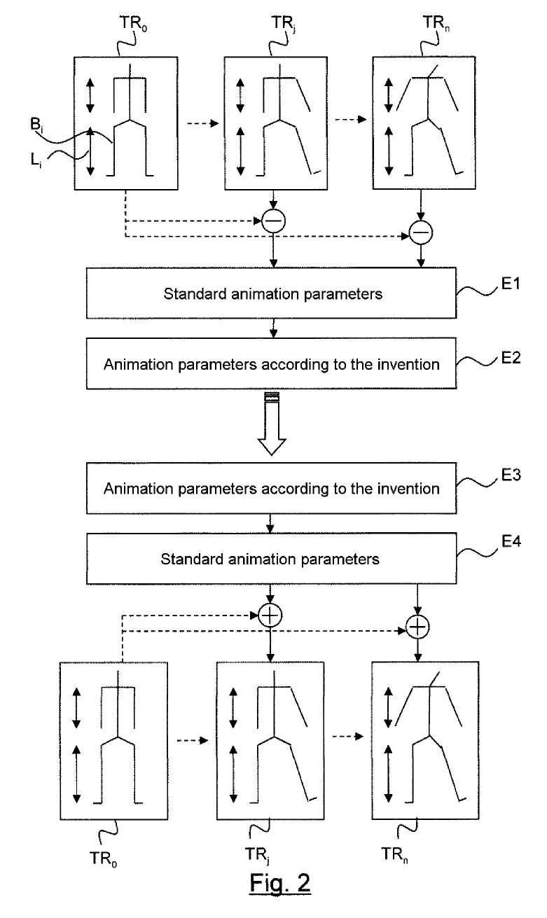

FIG. 2 is a chart illustrating the uses of the coding method and of the decoding method in accordance with the invention on a stream of successive transformations,

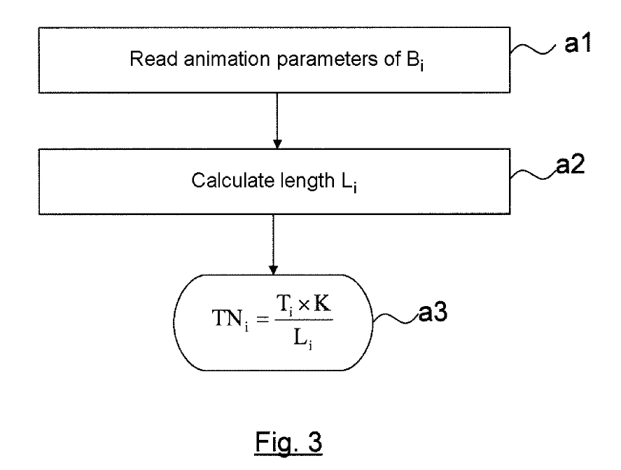

FIG. 3 illustrates steps of the coding method according to the invention,

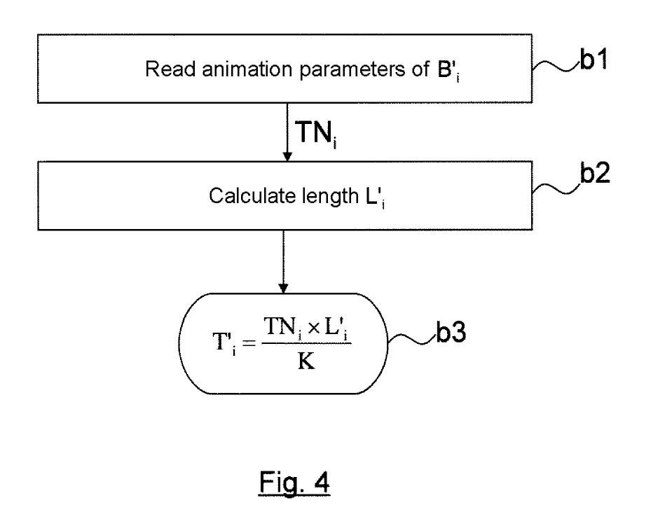

FIG. 4 illustrates steps of the decoding method according to the invention.

According to an embodiment of the invention, the coding method and the decoding method according to the invention use the MPEG 4 BBA standard for coding and decoding animation parameters determined on the basis of an avatar A represented in FIG. 1. It should be noted that although these animation parameters are determined on the basis of the avatar A, they are later reused to animate other avatars having the same typical skeleton as the avatar A, as described hereinafter.

This embodiment has the advantage of using, without parameter modifications, an existing standard, but other embodiments, for example integrating additional parameters into an existing standard for coding animation parameters, are conceivable. Moreover, the use of the methods according to the invention is not limited to characters having the typical skeleton defined by the HAnim standard. Specifically the methods according to the invention are usable on any type of avatar, with potentially different morphological criteria from the lengths of segments of the typical skeleton, for example the height or the width of the avatar.

A typical skeleton defined by the HAnim standard is associated with the avatar A to be animated. This skeleton is represented in FIG. 1 in the rest position defined by this standard. It is composed of segments and of articulation levels, which allow the animation of the geometry of the avatar. Thus the movements of the left forearm of the avatar A are calculated on the basis of the transformations applied to the segment Bₖ, and the movements of the right leg of the avatar A are calculated on the basis of the transformations applied to the segment Bₗ. With the articulation levels Nₖ and Nₗ corresponding respectively to the left elbow and to the right knee of the avatar are associated the rotation parameters corresponding respectively to the left forearm and to the right leg of the avatar.

The coding and decoding of the animation of the avatar A, or other avatars having the same typical skeleton, are performed by the coding and decoding methods according to the invention in accordance with steps E1 to E4 represented in FIG. 2.

The avatar A undergoes a succession of transformations TR₀ to TRₙ in the course of time.

In a first step E1 of the coding method in accordance with the invention, the successive transformations TRⱼ of the avatar are coded in an animation stream composed of successive “SBBone” structures for each segment Bᵢ of the skeleton of the avatar A. Each “SBBone” structure, the nomenclature of which is defined by the MPEG4 BBA standard and reproduced in Annex 1, codes the transformations of a segment identified by the number “boneID” with respect to its rest position specified by the HAnim standard.

The values of the animation parameters for the “SBBone” structure of Annex 1 correspond to the initial values of the transformation parameters with respect to the rest position of the avatar. These animation parameters are expressed in the reference frame local to the segment Bᵢ, the origin of this local reference frame being defined by the parameter “center”. This origin in fact corresponds to an articulation level of the typical skeleton. The “rotation” parameter for example equals (0 0 1 0), which indicates a zero angle rotation with respect to the (0 0 1) axis in this local reference frame.

It should be noted that in this embodiment according to the invention, the animation stream processed by the coding method according to the invention contains only transformations intrinsic to the avatar, the transformations extrinsic to the character being coded separately in a file in the BIFS or “Binary Format for Scenes” format, which codes the global parameters of the MPEG4 scene to be animated.

In a variant embodiment of the invention, an additional parameter is for example added to the “SBBone” structures of an animation stream, making it possible to determine whether the “translation” parameter of an “SBBone” structure codes a translation intrinsic or extrinsic to the avatar A. In this variant, a single animation stream is thus used to code transformations extrinsic and intrinsic to the avatar A, the “translation” parameter then being modified in the manner described in step E2 only for the translations intrinsic to the avatar.

As indicated earlier, in the main embodiment of the invention described here, no additional parameter is added to the MPEG4 BBA standard. In this first step E1 therefore, the coding of the animation parameters in the animation stream is performed while complying with the MPEG4 BBA standard in the meaning of each of the animation parameters.

In a second step E2 of the coding method according to the invention, the values of the translation parameters of the animation stream obtained in step E1 are modified so as to take account of the relative nature of the intrinsic translations of the avatar A. For this purpose, each “SBBone” structure of the animation stream is processed in accordance with steps a1 to a3 of FIG. 3:
Step a1 is the reading of the “endpoint” parameter of the “SBBone” structure considered, coding the animation parameters for a segment Bᵢ. This “endpoint” parameter contains the coordinates of the end of the segment Bᵢ which is not the origin of the reference frame local to the segment Bᵢ.
The following step a2 is the calculation of the length Lᵢ of the segment Bᵢ. This length is determined by calculating the norm of the vector contained in the “endpoint” parameter previously read.
The following step a3 is the modification of the translation value Tᵢ contained in the “translation” parameter, which expresses a translation in a system of absolute measurement units, so as to replace it with a translation value TNᵢ relating to the avatar A, and more precisely to the segment Bᵢ. The relative translation value TNᵢ in fact corresponds to the normalization of the absolute translation value Tᵢ by the length of the segment Bᵢ, according to the following equation:

$${TN}_{i} = \frac{{T}_{i} \times K}{{L}_{i}} ,$$

where K is a normalization factor.

The normalization factor K simply makes it possible to express TNᵢ on a scale lying between 0 and 10 for example. It is the same for all the segments Bᵢ and is fixed in advance by the users of the methods according to the invention. In this way no specific parameter is necessary for coding the normalization factor K in the animation stream.

The coding of the animation parameters for the avatar A according to steps E1 and E2 is performed in a coding device, for example in a software module of an animation engine. This coding device thereafter codes in binary the animation parameters thus modified in a stream in the BIFS format, so as to compress the animation data in a standard manner.

In order to be able to reuse these animation parameters for other avatars of the same typical skeleton as the avatar A, the designer of the animation adapts the “endpoint” fields of the “SBBone” structures of the avatar A to the skeleton of other avatars having the same typical skeleton. Specifically, since the translation parameters are coded in a relative manner, only the “endpoint” fields coding the length of the segments of the new avatars have to be modified. The coding device then creates other BIFS streams corresponding to the animation parameters for these other avatars.

The animation streams thus obtained in the form of BIFS files at the end of step E2 are transmitted on a communication network, to an animation engine remote from the previous one, separately from the morphological data of the avatar A, and optionally other avatars. The information signals corresponding to these animation streams therefore convey animation parameters, for which the translation parameters take account of the morphological values of the characters to be animated. In this embodiment of the invention, these information signals transmit only animation parameters intrinsic to the avatars and the morphological values taken into account are the lengths of the segments of the typical skeleton of these avatars.

As a variant, the information signals transmit at one and the same time animation parameters intrinsic to the avatars and animation parameters extrinsic to the avatars. In this case the information signals also each convey a parameter indicating the intrinsic or extrinsic nature of the translation parameters transmitted.

In a third step E3, it is assumed that the remote animation engine receives morphological data of a new avatar different from the avatar A, but exhibiting the same typical skeleton, as well as the associated BIFS animation stream. It should be noted that steps E3 and E4 described hereinafter are nevertheless transposable in the case where the animation engine receives morphological data of the avatar A and the animation stream corresponding to the avatar A. Specifically, the BIFS animation stream received in the two cases is the same, only the values of the “endpoint” fields are different, since they depend on the avatar to be animated.

The BIFS animation stream received in step E3 is decompressed by the remote client. The decoding method according to the invention is then used to perform an animation of the new avatar, on the basis of the data which have been decompressed on the basis of the BIFS file previously transmitted. The decoding method according to the invention is implemented in a specific module of the remote animation engine.

For this purpose each “SBBone” structure corresponding to a segment B′ᵢ of the typical skeleton of the new avatar in the file is processed in accordance with the decoding steps b1 to b3 of FIG. 4:
Step b1 is the reading of the “endpoint” parameter of the “SBBone” structure considered, coding the animation parameters for the segment B′ᵢ.
The following step b2 is the calculation of the length L′ᵢ of the segment B′ᵢ. This length is determined by calculating the norm of the vector contained in the “endpoint” parameter previously read.
The following step b3 is the modification of the relative translation value TNᵢ contained in the “translation” parameter, so as to replace it with a corresponding translation value T′ᵢ expressed in a system of absolute measurement units. The translation value T′ᵢ is calculated according to the following equation:

$${T}_{i}^{′} = \frac{{TN}_{i} \times {L}_{i}^{′}}{K}$$

where K is the normalization factor used in step E2.

The data thus decoded at the end of step E3 comply with the MPEG4 BBA standard for the coding of the animation parameters for the new avatar.

Step E4 is the reading of the data decoded in step E3 by the remote animation engine, and the animation of the new avatar with the animation parameters contained in these data. These animation parameters comply with the morphology of the new avatar, while having been designed on the basis of a different initial avatar A. Thus the translation parameters for the pelvis of the new avatar when it walks are adapted to its dimensions.

ANNEX 1

SBBone{ #% NDT=SFSBBoneNode, SF3DNode, SF2DNode

| | | | |
|---|---|---|---|
| eventIN | MF3DNode | addChildren | |
| eventIN | MF3DNode | removeChildren | |
| exposedField | SFInt32 | boneID | 0 |
| exposedField | MFInt32 | skinCoordIndex | [ ] |
| exposedField | MFFloat | skinCoordWeight | [ ] |
| exposedField | SFVec3f | endpoint | 0 0 1 |
| exposedField | SFInt32 | falloff | 1 |
| exposedField | MFFloat | sectionPosition | [ ] |
| exposedField | MFFloat | sectionInner | [ ] |
| exposedField | MFFloat | sectionOuter | [ ] |
| exposedField | SFInt32 | rotationOrder | 0 |
| exposedField | MFNode | children | [ ] |
| exposedField | SFVec3f | center | 0 0 0 |
| exposedField | SFRotation | rotation | 0 0 1 0 |
| exposedField | SFVec3f | translation | 0 0 0 |
| exposedField | SFVec3f | scale | 1 1 1 |
| exposedField | SFRotation | scaleOrientation | 0 0 1 0 |
| exposedField | SFInt32 | ikChainPosition | 0 |
| exposedField | MFFloat | ikYawLimit | [ ] |
| exposedField | MFFloat | ikPitchLimit | [ ] |
| exposedField | MFFloat | ikrollLimit | [ ] |
| exposedField | MFFloat | ikTxLimit | [ ] |
| exposedField | MFFloat | ikTyLimit | [ ] |
| exposedField | MFFloat | ikTzLimit | [ ] |
| } | | | |

1. A method for coding animation parameters for a character with which are associated morphological values, said animation parameters comprising a translation parameter associated with at least one part of said character, wherein to code an intrinsic translation of said part of said character by a translation vector, said translation parameter contains a value which is dependent on said vector and on one of said morphological values.

2. The coding method as claimed in claim 1, wherein one parameter from among said animation parameters makes it possible to determine whether said translation parameter codes a translation intrinsic to said character or a translation extrinsic to said character.

3. The coding method as claimed in claim 1, in which said morphological values are lengths of segments of the skeleton of said character, and in which said translation parameter is associated with a segment of the skeleton of said character, wherein to code an intrinsic translation of said segment by a translation vector, said translation parameter contains a value which is proportional to said vector and inversely proportional to the length of said segment.

4. A method for decoding animation parameters for a character with which are associated morphological values, said animation parameters comprising a translation parameter associated with at least one part of said character, wherein to decode an intrinsic translation of said part of said character, the value of said translation parameter is multiplied by a factor of one of said morphological values.

5. The decoding method as claimed in claim 4, in which said morphological values are lengths of segments of the skeleton of said character, said translation parameter being associated with a segment of the skeleton of said character, and in which, in order to decode an intrinsic translation of a segment of the skeleton of said character, said method comprises the steps of:
Calculating the length of said segment,
Obtaining an estimation of the value of said translation in a system of absolute measurement units, by multiplying the value of said translation parameter by a factor proportional to the previously calculated length of said segment.

6. A signal conveying animation parameters for a character with which are associated morphological values, said animation parameters comprising a translation parameter containing translation information for said part of said character in the form of a value included in said translation parameter, wherein said value has been evaluated as a function of one of said morphological values when said translation is intrinsic to the character.

7. The signal as claimed in claim 6, wherein it conveys a parameter making it possible to determine whether said translation is a translation intrinsic to the character or a translation extrinsic to the character.

8. A device for coding animation parameters for a character with which are associated morphological values, wherein it comprises means suitable for implementing a method as claimed in claim 1.

9. A device for decoding animation parameters for a character with which are associated morphological values, wherein it comprises means suitable for implementing a method as claimed in claim 4.

10. A computer program comprising instructions for implementing the method as claimed in claim 1, when it is executed on a computer.

11. A computer program comprising instructions for implementing the method as claimed in claim 4, when it is executed on a computer.
